(19) United States
(12) Patent Application Publication
(10) Pub. No.: US 2019/0295785 A1
(43) Pub. Date: Sep. 26, 2019

(54) Electronic Device Disconnection

(71) Applicants: Frederic Vladimir ESPOSITO DE LA TORELLA, Luton (GB); Eaton Intelligent Power Limited, Dublin 4 (IE)

(72) Inventor: Frederic Vladimir ESPOSITO DE LA TORELLA, Luton (GB)

(21) Appl. No.: 16/302,996

(22) PCT Filed: May 11, 2017
(86) PCT No.: PCT/GB2017/051315

§ 371 Date: Nov. 19, 2018

(30) Foreign Application Priority Data
May 19, 2016 (GB) 1608823.9

(51) Int. Cl. H01H 1/42; H01H 9/02; H01H 9/16

(52) U.S. Cl. CPC H01H 1/42; H01H 9/16; H01H 9/02

(57) ABSTRACT

The invention provides for an electronic functional device such as an isolator/barrier for input/output process connection to a plurality of field devices possibly operating in a hazardous environment, the functional device having mounted there-to a disconnect element, such as a knife disconnect element, so as to be associated therewith and to provide disconnect functionality between the field devices and the isolator/barrier device, the mounting of the disconnect element at the isolator/barrier device also serving to provide further indication of the field device associated with the disconnect element.

Various forms of electronic device find a wide variety of uses in a variety of process industries. In particular, field devices such as sensors and actuators, are commonly deployed in field locations within a process environment.

In view of the nature of such deployment potentially as part of complex, time-consuming and costly process control systems, the accuracy and reliability of operation of such field devices is paramount. Such devices are commonly subject to a wide range of test scenarios both during commissioning, and subsequently during their working lifetime.

Any such device-testing commonly requires disconnection of the device from its power/data lines. In order to prevent the device representing a potential danger hazard to test personnel, and to prevent damage to the device, a secure and reliable means for disconnection of the device is required, and that can advantageously also provide a clearly visible indication of disconnection.

Such disconnection can be required for a variety of reasons such as, for protection of field devices, for protection of I/O devices, for testing purposes, for configuration purposes and for device-disabling purposes.

So-called knife-disconnect switches have commonly been employed so as to provide for such reliable, and readily visible, disconnection.

Electronic devices such as, but not limited to, field devices commonly connect to appropriate process circuitry relevant to the specific process environment by way of a functional cabinet in which connection elements providing appropriate electrical functionality, such as barrier, isolation or other functional devices, whether alone or in combination, can be provided. With the field devices connecting to field side of the cabinet, input/output wiring at a process side then provides for connection to the appropriate process circuitry.

As an example, when a plurality of electronic devices are provided in a particular environment, such as a plurality of field devices within a hazardous process-environment, it becomes necessary to make appropriate connections form the field devices to appropriate respective barrier, isolation or other functional devices, within the function cabinet so that ongoing connections are made to the correct input/output wiring leading to the process circuitry.

Such connectivity between plural field devices and the functional devices such as barrier and/or isolator devices is commonly provided by a so-called marshalling cabinet comprising appropriately configured marshalling exchange wiring. This wiring connects the appropriate field device to the appropriate isolator type and/or barrier type and so for onward connection to the appropriate input/output wiring to the process circuitry.

The known disconnection means, such as known knife-disconnect switches, are mounted as part of a terminal block within the marshalling cabinet and thereby serve as ready means for disconnection at the point at which field device wiring enters the marshalling cabinet, and for ready indication as to which wiring connection, and the switch field device, is disconnected.

As noted, disconnection can be required for a variety of reasons such as, for protection of field devices, for protection of I/O devices, for testing purposes, for configuration purposes and for device-disabling purposes for example if such devices have not yet been fully commissioned.

Such known knife-disconnect switches therefore comprise integral elements of the functionality within the marshalling cabinets and thereby increase the potential importance, and requirement for the inclusion, of marshalling cabinets within a process control system employing for example a plurality of field devices noted above.

An alternative known disconnection configuration involves disconnection of an isolator from its socket but this only proves useful in rare arrangements in-which the device has been designed for that purpose. This solution still does not provide a full isolation between the lines of the same field device.

An object of the present invention is to provide a disconnection arrangement for plural electronic devices having advantages over known such arrangements.

In particular, the present invention seeks to provide for a disconnect arrangement which allows for the simplification of connectivity of a plurality of electronic field devices as commonly used within an intrinsically safe process environment.

According to a first aspect of the present invention there is provided an electronic functional device for input/output process connection to a plurality of field devices, the functional device including a disconnect element so as to be associated therewith and to provide disconnect functionality between a field device and the functional device, the disconnect element of the functional device further serving to provide visual indication of the field device associated with the disconnect element.

By mounting the plurality of disconnect elements to the functional device which also provides input/output process connectivity, reliable, and readily visible, disconnect arrangements can be provided while reducing the complexity and extent of the wiring and related cabinets.

Advantageously, the electronic functional device is integrated directly at a location where field device wiring connects to the functional device.

In one embodiment, the electronic functional device can exhibit zener barrier functionality.

In another embodiment, the electronic functional device can exhibit isolation functionality and in particular universal isolator functionality which can connect to almost any type of field device.

Advantageously, the invention provides for an electronic system element comprising a plurality of such electronic functional devices, and an associated plurality of disconnect elements.

In particular, the invention can provide for a functional device cabinet within which the said plurality of electronic functional devices, and associated disconnect elements, are mounted.

In one particular aspect, the invention comprises an isolator and/or barrier cabinet for use in the connection of plural field devices to input/output process wiring and process electronics.

Advantageously, a disconnect element can be provided with each of the field device lines entering the functional device cabinet.

As one example, the disconnect element can comprise a knife disconnect element.

In particular, the configuration of mounting the plurality of disconnect elements to the functional device, and particularly for a universal isolator, can reduce the functionality provided by, for example, a marshalling cabinet and can therefore advantageously reduce the requirement for an additional system element such as a marshalling cabinet.

The invention is described further hereinafter, by way of example only, with reference to the accompanying drawings in which:

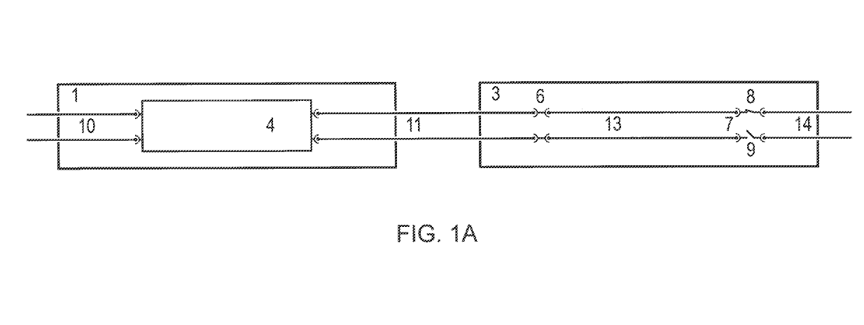

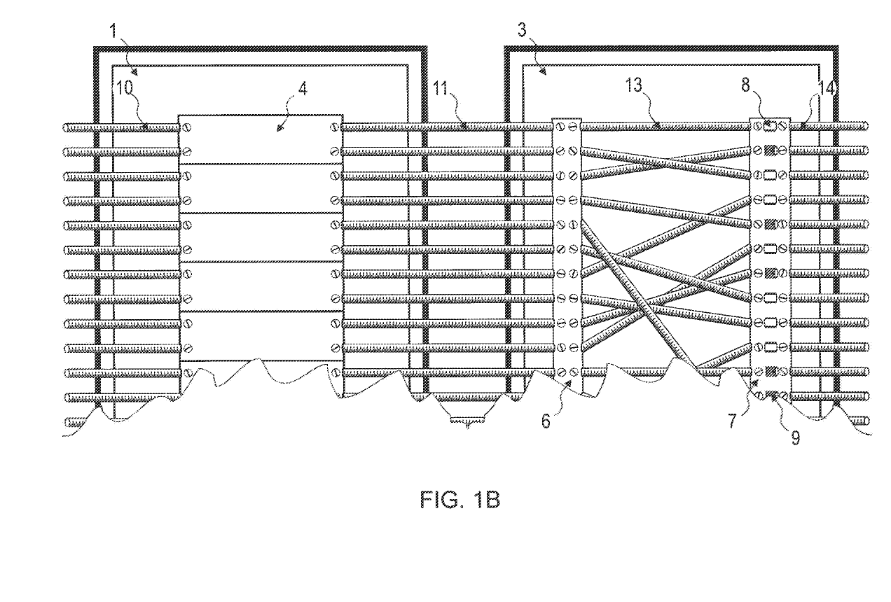

FIG. 1A comprises a schematic representation of the connectivity between a barrier/isolator cabinet and a marshalling cabinet for use in a common known connection scenario connecting field devices to electronic processing circuitry;

FIG. 1B is an enlarged detailed view of the configuration and connectivity within part of a cabinet such as that of FIG. 1A;

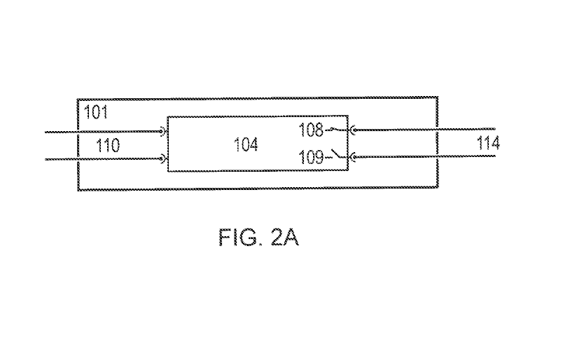

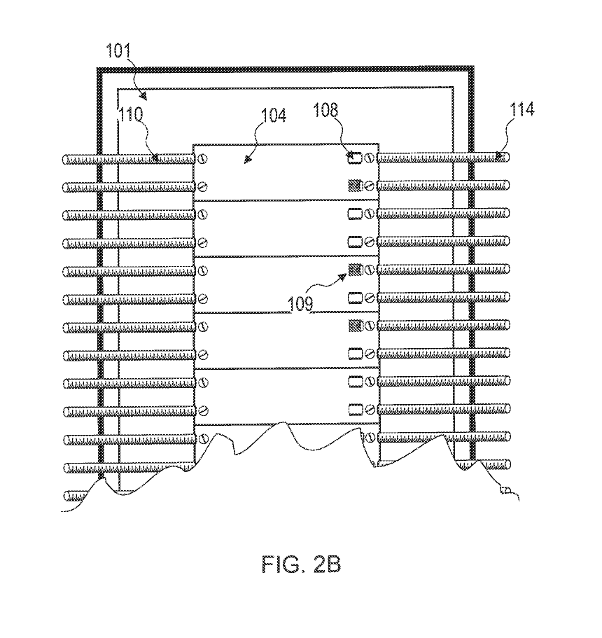

FIG. 2A is a schematic representation of a barrier/isolator cabinet according to one embodiment of the present invention; and

FIG. 2B is an enlarged detailed view showing the configuration and connectivity within part of the cabinet of FIG. 2A.

Turning first to FIG. 1A, there is schematically illustrated the connectivity between a plurality of field devices (not shown in the figure) and process electronics (also not shown in the figure). The arrangement comprises a functional cabinet 1 such as for example a barrier and/or isolator cabinet. The cabinet 1 in this illustration comprises a plurality of isolators 4. A marshalling cabinet 3 is connected to the isolator cabinet 1 by way of marshalling-to-isolator wiring 11. The marshalling cabinet 3 is connected to the plurality of field devices by means of field device wiring 14, The predetermined required connectivity to the various field devices by way of the field device wiring 14 is achieved by means of marshalling exchange wiring 13 connected between marshalling-to-isolator terminal 6 and marshalling-to-field device terminals 7. The marshalling-to-field device terminal 7 also includes knife-disconnect switches 8, 9 illustrated here with 8 in a closed state and 9 in an open state. These knife-disconnect switches 8, 9 provide for selective disconnection of the field devices from the marshalling cabinet and so from the onward connection through the isolators to the process electronics to allow for testing/removal/replacement of the field devices as required.

Further details of the isolator cabinet 1 and marshalling cabinet 3, in the internal connectivity, are illustrated with reference to FIG. 1B.

Here, the plurality of isolators 4 and their respective pairs of input/output lines 10 to the process circuitry are illustrated, as are corresponding pairs of marshalling-to-isolator lines 11 leading from the marshalling-to-isolator terminals 6 of the marshalling cabinet 3.

The particular selected configuration of the connectivity between the field device wiring 14, and thus the respective field devices, and the terminal 6 connecting to the marshalling-to-isolator wiring 11 is further illustrated by reference to the marshalling exchange wiring 13 within the marshalling cabinet 3 of FIG. 1B.

Also illustrated in the further details of FIG. 1B are the respective plurality of knife disconnect switches 8, 9 located on the terminal block of the marshalling-to-field device connection and for each of the field lines 14. The switches are again shown in either a closed state 8 or an open state 9.

The plurality of knife-disconnect switches 8, 9 provide for a ready means for achieving disconnection of each of the field devices and in a manner in which each respective field device can be reliably selected and its disconnection achieved and clearly visibly indicated through association of the knife-disconnect switch with the respective elements of the field device wiring 14.

However, the configuration illustrated with reference to FIG. 1A and FIG. 1B requires the provision of the separate marshalling cabinet, and marshalling exchange wiring etc. and so provides a requirement for the retention of that system element in the form of an intermediate cabinet between the field devices and the process electronics.

Turning now to FIG. 2A, there is provided a schematic representation of an example of the present invention embodied within an isolator cabinet 101.

As with the main configuration of FIG. 1A, the configuration of FIG. 2A provides for connectivity, by way of input/output wiring 110 to process electronics (not shown), and for connection, by way of field device wiring 114 to a plurality of filed devices (also not shown).

This aspect of the invention is embodied within an isolator cabinet 101 including a plurality of isolators 104 and wherein knife-disconnect elements 108, 109 are provided directly on, and in this example effectively integral with, the isolators 104 and preferably located at the point of connectivity of the field device wiring 114 to the isolator 104. The knife-disconnect element 108 is shown in its closed state, and the knife-disconnect element 109 is shown in its open state.

Further detail of part of the cabinet 101 of FIG. 2A is illustrated in the enlarged view of FIG. 2B.

Here, as for comparison with FIG. 1B, this illustrated part of the isolator cabinet 101 comprising the plural series of isolators 104 each providing connectivity by way of the input/output wiring 110 to process electronics (not shown) and by way of the field device wiring 114 to a plurality of field devices (not shown).

The knife-disconnect switches 108, 109 can be readily switched between closed 108, and open 109, positions as required so as to achieve the appropriate disconnection for one or more of the field devices.

However, by locating the disconnection elements comprising, in the illustrated example, the knife-disconnect switches 108, 109 directly on or in relation to the isolators 104, the advantages of a reliable, and easily visibly indicated, disconnection for the field devices can be retained but in a manner not providing a further incentive for inclusion of the additional system element such as the marshalling cabinet. The particular disconnect arrangement of the present invention as illustrated in FIG. 2B allows for the provision of an effective/reliable openable/closeable connectivity between field devices and process electronics and in a manner which does not influence/affect the possibility for omission of the marshalling cabinet. The same functionality illustrated with reference to FIG. 1B, can therefore likewise be provided by means of the simpler, more space-efficient less costly connection arrangement illustrated with reference to FIG. 2B. Essentially, in the illustrated examples, the same functionality of the prior art can be achieved without a marshalling cabinet 3 such as found in the prior art, which can lead to particularly advantageous space and cost savings and an overall generally simpler connectivity configuration which is inherently far less vulnerable to wiring/connection errors.

It should of course be appreciated that the invention is not restricted to the details of the illustrated embodiment. In particular, the integral location of the disconnect elements such as the knife-disconnect switches can be provided in relation to any appropriate functional element that can be arranged within a related functional cabinet such as barrier devices/cabinets barrier-isolator device/cabinets and any other appropriate functional device and related functional device cabinet. The invention can also be provided with any appropriate number of input/output wire connections to process electronics and in relation to connectivity to any appropriate/required number and selection of field devices.

1. A functional device for input/output process connection to a plurality of field devices, the functional device comprising:
an integrated disconnect element to provide disconnect functionality between at least one field device of the plurality of field devices and the functional device, the disconnect element of the functional device configured to provide visual indication of the at least one field device associated with the disconnect element.

2. The functional device as claimed in claim 1, wherein the disconnect element is integrated directly at a location where field device wiring connects to the functional device.

3. The functional device as claimed in claim 1, wherein the disconnect element comprises a knife disconnect element.

4. The functional device as claimed in claim 1 in combination with one or more additional functional devices of a field-device connection system wherein at least part of the connectivity of the system is by way of an arrangement of the functional device and the one or more additional functional devices.

5. The functional device as claimed in claim 1 in combination with a functional device cabinet, wherein the functional device is mounted in the functional device cabinet.

6. The functional device as claimed in claim wherein the functional device cabinet is an isolator and/or barrier cabinet for use in the connection of a plurality of field devices to input/output process wiring and process electronics.

7. The functional device as claimed in claim 6, wherein the disconnect element is provided in relation to field device lines entering the cabinet.

8. (canceled)

9. (canceled)
